(19) United States
(12) Patent Application Publication
(10) Pub. No.: US 2005/0216579 A1
(43) Pub. Date: Sep. 29, 2005

(54) System and method for managing equipments

(76) Inventors: Hao-Ching Yang, Tainan County (TW); Chun-Yen Teng, Tainan County (TW)

Correspondence Address: PRO-TECHTOR INTERNATIONAL SERVICES, 20775 Norada Court, Saratoga, CA, 95070-3018, US

(21) Appl. No.: 10/937,234

(22) Filed: Sep. 8, 2004

(30) Foreign Application Priority Data
Mar. 24, 2004 (TW) 93108023

(51) Int. Cl. G06F 15/173

(52) U.S. Cl. 709/223

(57) ABSTRACT

A system and a method for managing equipments are disclosed for unifying the transmission interfaces between each of the equipments and an equipment manager. The system for managing the equipments comprises the equipment manager and a plurality of equipment controllers connected to the equipment manager, each of the equipment controllers controls at least one equipment. The method for managing the equipments is to convert equipment message transmitted from the equipments to equipment drive information having a unified message format, wherein the equipment drive information is transmitted to the equipment manager. The equipment controllers also generate equipment interface information deployed to the equipments appropriately. The method for managing the equipments further comprises defining variable IDs; defining a data structure and a schema file; and defining scenarios.

### FIELD OF THE INVENTION

The present invention relates to a system and a method for managing equipments, and more particularly, to the system and the method for managing equipments with a unified message format.

### BACKGROUND OF THE INVENTION

Since an IC fabrication involves complicated manufacturing steps, expensive processing equipments, numerous product varieties and short product life cycles, IC makers have to apply computer integrated manufacturing (CIM) procedures for properly utilizing all kinds of manufacturing resources by controlling material and information flows. The so-called CIM is centralized in a database by means of computers, and then through a computer networking, passes the information stored in the database to users speedily, or integrates various automatic facilities into an integrated automatic production system. In January 1997, from an article in Semiconductor International Journal, it is reported that “the installation of a CIM system is mission-critical in the start-up of new fabs and in the on-going development of current ones”, wherein MES (Manufacturing Execution system) is the core of CIM.

Referring to FIG. 1, FIG. 1 is a schematic diagram showing the operation of a conventional MES, wherein the MES 10 monitors a plurality of equipment managers 20, and each of the equipment managers 20 monitors a plurality of equipments 31, 32, 34 and 36. The MES 10 is in charge of executing most of the procedures, and also stores all the information to a system database 60. After the MES 10 issues a command to the equipment manager 20, the equipment manager 20 then orders the equipments 31 to start production. The MES 10 is also equipped with a web server 50, so that a remote client 40 can access the information through a web browser.

The equipments 31, 32, 34 and 36 can report individual equipment messages, such as current equipment situations (for example, working mode, pending mode, maintenance mode or shutdown mode, etc.); operation parameters; abnormal conditions or alarms, to the equipment manager 20, so that the equipment manager 20 can inform the MES 10 or production personnel of the most updated status of each equipment. However, since the equipments 31, 32, 34 and 36 all use different transmission interfaces for transmitting equipment messages, such as a PLC (Programmable logic controller) transmission interface 41, a SCADA (Supervisory control and data acquisition) transmission interface 42, a RS-232 transmission interface 44 and a file transmission interface 46, etc., a lot of manpower and material resources often have to be taken to individually modify the transmission interfaces between the equipment manager 20 and the equipments 31, 32, 34 and 36, thereby parsing the equipment messages returned via various transmission interfaces from the equipments. Thereafter, the production personnel may process necessary treatments on several relevant equipments, and meanwhile, the jobs executed on the relevant equipments have to be temporarily stopped, thus causing production delay. In addition, each equipment manager 20 is often in charge of dozens or hundreds of equipments, and has quite a heavy load, so that it takes a lot of time for the equipment manager to handle the equipment message, and the required settings of the equipments cannot be adjusted in time, thus resulting in mass product scram and severe production loss.

Hence, there is an urgent need to develop a system and a method for managing equipments, thereby unifying the transmission interfaces between the equipment manager and the equipments; parsing the equipment messages in real time and enabling the equipment manager to change the required settings of the equipments automatically so as to assure smooth production.

### SUMMARY OF THE INVENTION

An aspect of the present invention is to provide a system and a method of managing equipments for unifying transmission interfaces between equipments and an equipment manager, so that the equipment messages returned via various interface transmission from the equipments can be parsed without modifying the transmission interfaces.

Another aspect of the present invention is to provide a system and a method of managing equipments for parsing equipment messages in real time, thereby enabling the equipment manager to change the required settings of the equipments in time for assuring smooth production.

Another aspect of the present invention is to provide a system and a method of managing equipments for increasing the efficiency for collecting the equipment messages; promoting the reliability, flexibility and robustness of equipment management; reducing the load of the equipment manager; allowing users to renew the collection items of the equipment messages remotely; and meeting the real-time functional requirements of the production cell information system.

According to the aforementioned aspects, a system and a method for managing equipments are provided for being applicable to a plurality of equipment controllers.

According to an embodiment of the present invention, the system for managing equipments includes an equipment manager and a plurality of equipment controllers connected to the equipment manager. Each of the equipment managers is in charge of at least one equipment for converting equipment messages transmitted from the equipments to equipment drive information having a unified message format, and the equipment drive information is transmitted to the equipment manager. After the equipment manager deploys the equipment drive information appropriately on the equipment controllers, each of the equipment controllers generates and deploys equipment interface information on the equipments.

Each of the equipment controllers includes a variable-ID (Identification) defining means, a data-structure defining means, a scenario defining means, an equipment-drive-information generating means, and an equipment-interface-information generating means. The variable-ID defining means is used for generating a plurality of variable IDs. The data-structure defining means is used for generating a data structure to arrange the equipment messages, and the records in the data structure are corresponding to the variable IDs. The scenario defining means is used for defining a plurality of scenarios related to the variable IDs, and for generating a plurality of actions and a plurality of scenario message. The equipment-drive-information generating means is used for converting the equipment messages to the equipment drive information in accordance with the variable IDs, the actions and the scenario messages. The equipment-interface-information generating means is used for generating the equipment interface information via the data structure, the actions and the scenario messages in accordance with the equipment drive information. Further, each of the equipment controllers includes a schema file used for validating the message contents of the equipment drive information and the equipment interface information, and for unifying the naming conventions of the equipment drive information and the equipment interface information.

In the method of the present invention for managing equipments, a plurality of variable IDs and a data structure are defined, wherein the data structure is used for arranging each of equipment messages generated from the equipments, and the records in the data structure are corresponding to the variable IDs. Then, a plurality of scenarios related to the variable IDs are defined, and a plurality of actions and a plurality of scenario messages are generated. Thereafter, the equipment messages are converted to the equipment drive information having a unified message format in accordance with the variable IDs, the actions and the scenario messages. Then, the equipment interface information is generated via the data structure, the actions and the scenario messages in accordance with the equipment drive information.

Hence, with the application of the present invention, the transmission interfaces between the equipment manager and the equipments can be unified; the equipment messages can be parsed in real time, and the equipment manager can automatically change the required settings of the equipments in time; the efficiency for collecting the equipment messages can be promoted; the reliability and robustness of equipment management can be enhanced; the load of the equipment manager can be reduced; users can be allowed to renew the collection items of the equipment messages remotely; and the real-time functional requirements of the production cell information system can be satisfied.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing the operation of a conventional MES;

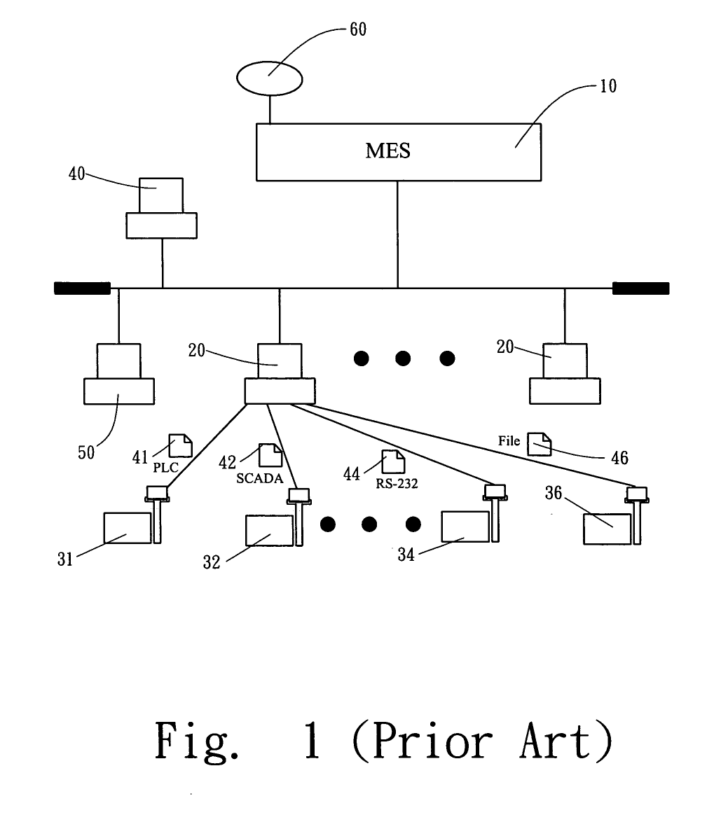

FIG. 2 is a schematic diagram showing a system for managing equipments according to the present invention; and

FIG. 3 is a schematic diagram showing a method for managing equipments according to the present invention.

### DETAILED DESCRIPTION OF THE PREFERRED EMBODIMENT

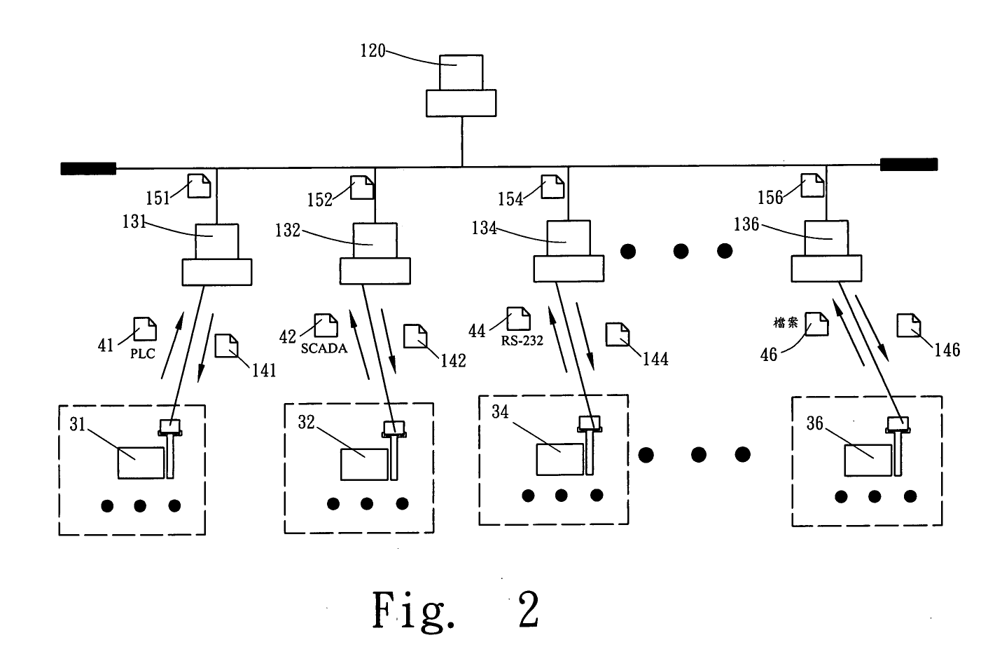

The present invention is featured in using equipment controllers to be in charge of managing equipments having different transmission interfaces, and transmitting equipment drive information having a unified message format to an equipment manager. Referring to FIG. 2, FIG. 2 is a schematic diagram showing a system for managing equipments according to the present invention, wherein an equipment controller 131 is in charge of controlling at least one equipment 31 using a PLC transmission interface, and an equipment controller 132 is in charge of controlling at least one equipment 32 using a SCADA transmission interface, and an equipment controller 134 is in charge of controlling at least one equipment 34 using a RS-232 transmission interface, and an equipment controller 136 is in charge of controlling at least one equipment 36 using a file transmission interface. The aforementioned PLC, SCADA, RS-232 and file transmission interfaces are merely stated as examples for explanation, and the present invention is not limited thereto.

After the equipments 31, 32, 34 and 36 transmit equipment messages 41, 42, 44 and 46 respectively to the equipment controllers 131, 132, 134 and 136, the equipment controllers 131, 132, 134 and 136 convert the equipment messages 41, 42, 44 and 46 respectively to equipment drive information 151, 152, 154 and 154 with a unified message format, and transmit the equipment drive information 151, 152, 154 and 156 to an equipment manager 120, wherein the contents of the equipment drive information may include the operation or data-retrieval of other equipments. After the equipment manager 120 deploys the contents of the equipment drive information 151, 152, 154 and 156 appropriately on the respective equipment controllers 131, 132, 134 and 136, the equipment controllers 131, 132, 134 and 136 generate and deploy equipment interface information 141, 142, 144 and 146 appropriately on the respective equipments 31, 32, 34 and 36, thereby changing the required equipment settings and renewing the collection items of the machine messages, etc.

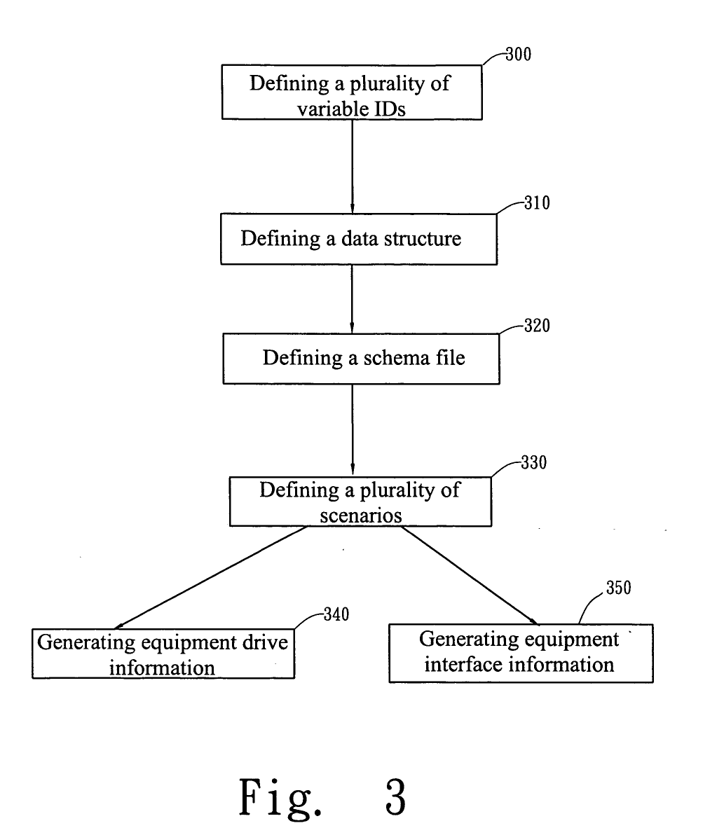

Referring to FIG. 3, FIG. 3 is a schematic diagram showing a method for managing equipments according to the present invention. The present invention is further featured in enabling each of the equipment controllers to define variable IDs and a data structure with respect to the specific transmission interfaces of the equipments controlled thereby, so as to convert the equipment messages to the equipment drive information with a unified message format. At first, step 300 is performed to define a plurality of variable IDs, wherein the variable IDs can be composed of several (such as 15) alphabets or numerals, and each of alphabets or numerals stands for a production line name, a production line number, a process name, an equipment number, a data type and a serial number (system or user defined serial number) etc. For example, in a variable ID: H1-BAT01-P-0001, from left to right, “H” stands for the production line name: “Hot End”; “1” stands for the production line number; “BAT” stands for the process name: “Batching Process”; “01” stands for the equipment number; “P” stands for the data type: “Process”; and “0001” stands for the serial number.

After the variable IDs are completely defined, step 310 is performed to define a data structure for arranging the equipment messages generated from the equipments, wherein the records in the data structure are corresponding to the variable IDs. The data structure can be defined in accordance with industrial standard specifications, such as SECS (Semiconductor Equipment Communication Standard), SEMI SECS I (E4), SEMI SECS I (E5), GEM (E30), HSMS (E37) or OBEM (E98), etc., so that the equipments having standard specifications can be conveniently added. The present invention can use such as SECS to establish a data structure, and then converts various transmission interface structures to new structures all using SECS, and also makes the new structures corresponding to the variable IDs. For example, the commands, codes, naming conventions used in SCADA transmission interface are converted to those used in SECS, and are corresponding to the variable IDs.

Thereafter, step 320 is performed to define a schema file used for validating the contents of the equipment drive information and equipment interface information generated subsequently, and for unifying the naming conventions thereof. Thereafter, step 330 is performed to define a plurality of scenarios related to the variable IDs, and to generate a plurality of actions and a plurality of scenario messages, wherein several different abnormal conditions or operating steps can be combined in those scenarios for further providing the flexibility of equipment management. Thereafter, step 340 is performed to convert the equipment messages to equipment drive information in accordance with the variable IDs, the actions and the scenario messages. Then, step 350 is performed to generate the equipment interface information via the data structure, the actions and the scenario messages in accordance with the equipment drive information.

Since most of the aforementioned steps are performed in the equipment controllers, each of the equipment controllers includes a variable-ID defining means used for generating a plurality of variable IDs; a data-structure defining means used for generating a data structure to arrange equipment messages, wherein the records in the data structure are corresponding to the variable IDs; a scenario defining means used for defining a plurality of scenarios related to the variable IDs, and generating a plurality of actions and a plurality of scenario messages; an equipment-drive-information generating means used for converting the equipment messages to at least one equipment drive information in accordance with the variable IDs, the actions and the scenario messages; an equipment-interface-information generating means used for generating at least one equipment interface information via the data structure, the actions and the scenario messages in accordance with the equipment drive information; and a schema file, wherein the schema file is used for validating the message contents and unifying the naming conventions.

It is worthy to be noted that the present invention uses an equipment controller to execute most of the functions originally belonging to an equipment manager, so that the load of the equipment manager can be greatly reduced. Meanwhile, the equipment controller can be individually designed to satisfy the real-time functional requirements for a production cell information system. Since multitudes of equipment-monitoring jobs are distributed over respective equipment controllers, by additionally unifying the transmission interfaces between the equipment manager and the equipments, the equipment manager can automatically allocate equipment drive information to the equipment controllers related to the managed equipments, and then the equipment controllers generate equipment interface information with respect to the specific transmission interface of each equipment, so as to effectively assure smooth production.

Hence, it can be known from the aforementioned embodiments that the present invention has the following advantages. The transmission interfaces between the equipment manager and the equipments can be unified, so that equipment messages returned via various transmission interfaces from the equipments can be effectively parsed without modify the transmission interfaces therebetween one by one; the equipment messages can be parsed in real time, and the equipment manager can automatically change the required settings of the equipments in time, thereby assuring smooth production; the efficiency for collecting the equipment messages can be promoted; the reliability and robustness of equipment management can be enhanced; the load of the equipment manager can be reduced; users can be allowed to renew the collection items of the equipment messages remotely; and the real-time functional requirements of the production cell information system can be satisfied.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

1. A system for managing equipments, said system comprising:
an equipment manager; and
a plurality of equipment controllers connected to said equipment manager, wherein each of said equipment controllers is in charge of controlling at least one equipment for converting each of equipment messages transmitted from said at least one equipment to equipment drive information having a unified message format, and said equipment drive information is transmitted to said equipment manager, and, after said equipment manager deploys said at least one equipment drive information appropriately on said equipment controllers each of said equipment controllers generates and deploys at least one equipment interface information on said at least one equipment.

2. The system for managing equipments according to claim 1, wherein each of said equipment controllers comprises:
a variable-ID (Identification) defining means used for generating a plurality of variable IDs;
a data-structure defining means used for generating a data structure to arrange said equipment messages, wherein the records in said data structure are corresponding to said variable IDs;
a scenario defining means used for defining a plurality of scenarios related to said variable IDs, and generating a plurality of actions and a plurality of scenario messages;
an equipment-drive-information generating means used for converting said equipment messages to said at least one equipment drive information in accordance with said variable IDs, said actions and said scenario messages; and
an equipment-interface-information generating means used for generating said at least one equipment interface information via said data structure, said actions and said scenario messages in accordance with said at least one equipment drive information.

3. The system for managing equipments according to claim 2, wherein each of said equipment controllers further comprises:
a schema file, where said schema files is used for validating the message contents of said at least one equipment drive information and said at least one equipment interface information, and is used for unifying the naming conventions of said at least one equipment drive information and said at least one equipment interface information.

4. The system for managing equipments according to claim 2, wherein said data structure is defined in accordance with SECS (Semiconductor Equipment Communication Standard).

5. The system for managing equipments according to claim 1, wherein the transmission interface for said equipment to transmit said equipment messages is selected from the group consisting of a SCADA (Supervisory control and data acquisition) transmission interface, a PLC (Programmable logic controller) transmission interface, a RS-232 transmission interface and a file transmission interface.

6. A method for managing equipments, applied in a plurality of equipment controllers, wherein each of said equipment controllers is in charge of controlling at least one equipment, said method comprising:
defining a plurality of variable IDs;
defining a data structure used for arranging each of equipment messages generated from said at least one equipment, wherein the records in said data structure are corresponding to said variable IDs;
defining a plurality of scenarios related to said variable IDs, and generating a plurality of actions and a plurality of scenario messages;
converting said equipment messages to said at least one equipment drive information having a unified message format in accordance with said variable IDs, said actions and said scenario messages; and
generating said at least one equipment interface information via said data structure, said actions and said scenario messages in accordance with said at least one equipment drive information.

7. The method for managing equipments according to claim 6, further comprising:
defining a schema file, wherein said schema files is used for validating the message contents of said at least one equipment drive information and said at least one equipment interface information, and is used for unifying the naming conventions of said at least one equipment drive information and said at least one equipment interface information.

8. The method for managing equipments according to claim 6, wherein said data structure is defined in accordance with SECS.

9. The method for managing equipments according to claim 6, wherein the transmission interface for said equipment to transmit said equipment messages is selected from the group consisting of a SCADA transmission interface, a PLC transmission interface, a RS-232 transmission interface and a file transmission interface.

10. The method for managing equipments according to claim 6, wherein said equipment controllers are connected to an equipment manager.

11. The method for managing equipments according to claim 10, wherein said equipment drive information is transmitted to said equipment manager.

12. The method for managing equipments according to claim 10, wherein, after said equipment manager deploys said at least one equipment drive information appropriately on said equipment controllers each of said equipment controllers generates and deploys at least one equipment interface information on said at least one equipment.
